(19) United States
(12) Patent Application Publication
(10) Pub. No.: US 2013/0273786 A1
(43) Pub. Date: Oct. 17, 2013

(54) ELECTRICAL POWER STAB SYSTEM AND METHOD FOR MAKING SAME

(71) Applicants: Abdolmehdi Kaveh Ahangar, Cedarburg, WI (US); Steven Charles Kaishian, Wauwatosa, WI (US)

(72) Inventors: Abdolmehdi Kaveh Ahangar, Cedarburg, WI (US); Steven Charles Kaishian, Wauwatosa, WI (US)

(73) Assignee: ROCKWELL AUTOMATION TECHNOLOGIES, INC., Mayfield Heights, OH (US)

(21) Appl. No.: 13/445,281

(22) Filed: Apr. 12, 2012

(51) Int. Cl. H01R 4/48; H01R 43/00

(52) U.S. Cl. 439/786; 29/825

(57) ABSTRACT

A power stab fork system is provided for power stab systems. The system comprises stab forks made of a steel layer bonded to a layer of highly conductive material such that the highly conductive material effectively conducts power with stabs while the steel layer keeps the stab fork in robust contact with the stab because of its stronger material properties. The stab forks may comprise a plurality of fingers for making independent contacts points onto a stab. Some embodiments included stab forks with one forked end, two forked ends, straight fingers, curved fingers, separated stab forks, conjoined stab forks, and so forth.

### BACKGROUND

The invention relates generally to the field of power supply and distribution, such as that to and with motor control centers. Specifically, the invention relates to techniques for connecting incoming power supply to certain types of electrical machinery.

Systems that distribute electrical power for residential, commercial, and industrial uses can be complex and widely divergent in design and operation. Electrical power generated at a power plant may be processed and distributed via substations, transformers, power lines, and so forth, prior to receipt by the end user. The user may receive the power over a wide range of voltages, depending on availability, intended use, and other factors. In large commercial and industrial operations, the power may be supplied as three phase AC power (e.g., 208 to 690 volt AC, and higher) from a main power line to a power management system. Power distribution and control equipment then conditions the power and applies it to loads, such as electric motors and other equipment. In one exemplary approach, collective assemblies of protective devices, control devices, switchgear, controllers, and so forth are located in enclosures, sometimes referred to as “motor control centers” or “MCCs”. Though the present technique is discussed in the context of MCCs, the technique may apply to power management systems in general, such as switchboards, switchgear, panelboards, pull boxes, junction boxes, cabinets, other electrical enclosures, and so forth.

The MCC may manage both application of electrical power, as well as data communication, to the loads, such loads typically including various machines, actuators and motors. Within the MCC may be disposed a variety of components or devices used in the operation and control of the loads. Exemplary devices contained within the MCC are motor starters, overload relays, circuit breakers, and solid-state motor control devices, such as variable frequency drives, programmable logic and automation controllers, and so forth. The MCC may also include relay panels, panel boards, feeder-tap elements, and the like. Some or all of the devices may be affixed within various “units” (or “buckets”) within the MCC. The MCC typically includes a steel enclosure built as a floor mounted assembly of one or more vertical sections containing the units or buckets. An MCC vertical section may stand alone as a complete MCC, or several vertical sections may be positioned and bused together. Exemplary vertical sections common in the art are 20 inches wide by 90 inches high.

The MCC normally interfaces with (and contains) power buses and wiring that supply power to the units and components, as sell as from the components to the loads. For example, the MCC may house a horizontal common power bus that branches to vertical power buses at each MCC vertical section. The vertical power buses then extend the common power supply to the individual units or buckets. To protect the power buses from physical damage, both the horizontal and vertical buses may be housed in enclosures, held in place by bus bracing or brackets, bolted to molded supports, encased in molded supports, and so forth. Other large power distribution equipment and enclosures typically follow a somewhat similar construction, with bus bars routing power to locations of equipment within the enclosures.

To electrically couple the MCC units or buckets to the vertical bus, and to simplify installation and removal, the units may be provided with self-aligning electrical connectors or metal “stabs” on the back of each unit. To make the power connections, the stabs, which may comprise spring-supported clamp devices, engage metal bus bars or conductive elements connected to the bus bars. For three phase power, three stabs per unit may accommodate three bus bars for the incoming power to provide power at the units. An optional ground or neutral bus may also be used. Within the unit, three stab wires or power lead wires may route power from the stabs to a disconnecting device or component, typically through protective devices such as fuses and circuit breakers. It should be noted that though three phase AC power is discussed, the MCCs may also manage single phase AC power, as well as DC power (e.g., 24 volt DC power for sensors, actuators, and data communication). Moreover, the individual units or buckets may connect directly to the horizontal common bus by suitable wiring and connections.

One continuing issue in such systems ensuring the quality of the electric connection made between the stab and the bus bars disposed on the vertical bus. The bus bars are traditionally made of copper or allow material to facilitate the flow of electricity. A separate spring or clamp is then generally used to hold the bus bars in intimate contact with the stab. However, this method can be costly and cumbersome, and may not offer optimal connectivity over time. In particular, the spring forces that serve to ensure good connections may not be consistent, consistently distributed, and may decay over time due to material creep, temperature variation, and so forth. Thus, there is a need for a more efficient and effective means of disposing a stab in intimate contact with a stab receptacle.

### BRIEF DESCRIPTION

In an exemplary embodiment, an electric power stab system includes first and second conductors disposed in mutually facing relation, each conductor comprising a conductive layer on an inner side of the conductor and a spring biasing layer bonded on an outer side of the conductor, the conductive layer comprising a metal of substantially higher conductivity than the spring biasing layer, the spring biasing layers urging the conductive layers towards a mating stab element when inserted between the first and second conductors for carrying electrical current primarily through the conductive layer.

In another embodiment, a similar system includes a conductive material bonded to a material of high elastic modulus, wherein portions of the bonded material face each other, conductive sides being on the inside and the high elastic modulus material being on the outside so that the conductive material is urged towards a contact position by the high elastic modulus material.

In another embodiment, a method includes bonding a conductive material to a spring steel material to form an electrical stab contact, wherein the conductive material is at least as thick as the steel material.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of one embodiment of a stab fork assembly, in accordance with the present disclosure;

FIG. 2 is a detailed view of a tip of the stab fork assembly of FIG. 1;

FIG. 3 is a perspective view of an embodiment of an alternative stab fork assembly;

FIG. 4 is a perspective view of an embodiment of a further stab fork assembly;

FIG. 5 is a perspective view of an embodiment of another alternative stab fork assembly;

FIG. 6 is a perspective view of a stab fork assembly receiving a stab, in accordance with the present disclosure;

FIG. 7 illustrates an embodiment of a stab fork assembly having a continuous base;

FIG. 8 illustrates an embodiment of a stab fork assembly having a continuous base and inwardly curving tips;

FIG. 9 is a perspective view of a power stab system in functional relation to a stab connector device, in accordance with the present disclosure; and

FIG. 10 is a diagrammatical view of a method for making a stab fork assembly, in accordance with the present disclosure.

### DETAILED DESCRIPTION

Referring generally to FIG. 1, one embodiment of a stab fork assembly 10 is illustrated. The embodied stab fork assembly 10 includes two stab forks 12 disposed in generally mutually facing relation. Each of the stab forks 12 further comprises a base 14, a body 16 comprising a plurality of fingers 18 separated by a plurality of slits 20, and outwardly bending tips 22 where the fingers 18 terminate. The body 16 is generally disposed at an angle in relation to the base 14. Specifically, the body 16 is generally vertically oriented, while the base 14 is generally horizontally oriented, or vice versa, depending on the viewing angle, as illustrated in FIG. 1. The two tips 22 generally bend outwardly toward opposing directions, forming a primary contact region 24 between the stab forks 12 at the point of inflection of the outwardly bending tips. The primary contact region 24 is generally where a stab would first make contact with the stab fork assembly 10 during making of the connection. The base 14 of the stab forks 12 may include apertures 26, as shown in FIG. 1, or other forms of attachment mechanisms for securing the stab fork assembly 10 to a bus bar or other structure.

Still referring to FIG. 1, the stab forks 12 are generally composed of a spring steel layer 28 and a conductive layer 30. The conductive layer 30 is disposed on the inner side of each stab fork 12 such that when two stab forks 12 are disposed in mutually facing fashion, the conductive layer 30 of one stab fork 12 is facing the conductive layer 30 of the other stab fork 12. Accordingly, the steel layer 28 of each stab fork 12 face outward and away from the stab fork assembly 10.

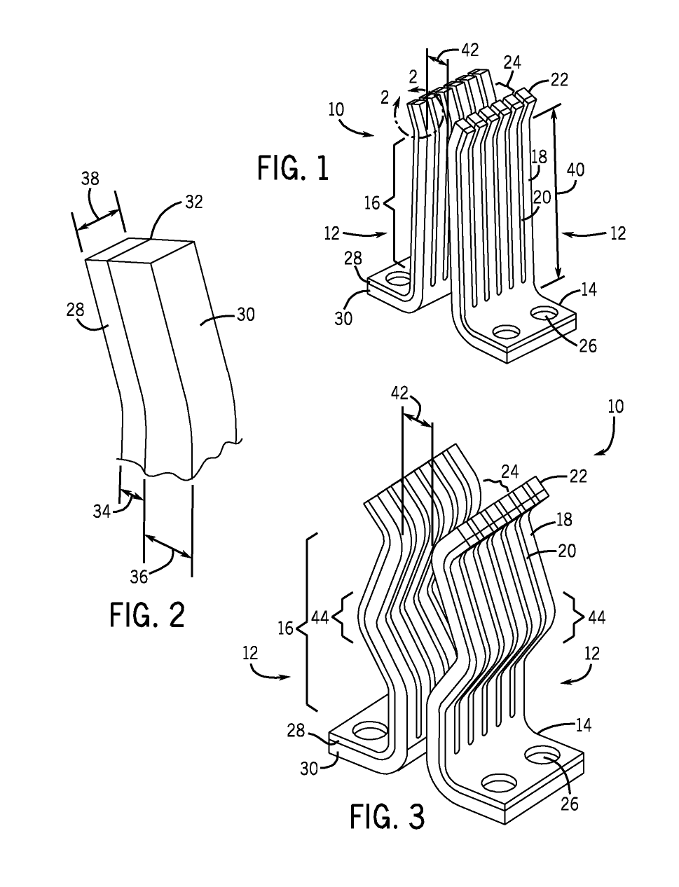

Referring now to FIG. 2, a detailed view of the tip 22, the steel layer 28 and the conductive layer 30 are bonded together at a bond seam 32. It is important to note that the neither the steel layer 28 nor the conductive layer 30 should be considered a coating or plating layer as is commonly used in some industries and applications, with one material being much less massive and thick than the other. Rather, the steel layer 28 and the conductive layer 30 of a stab fork 12 may be of relatively comparable mass, in which the conductive material is at least as thick as the steel material. Many factors, including the steel thickness and its elastic properties, the conductive material thickness, finger width 38, finger length 40, the number of fingers, and the desired contact force affect the performance of a stab fork assembly 10.

The illustrated embodiments generally comprise one steel layer bonded to one conductive layer in the manner discussed. However, some other embodiments may have multiple layers of either material, and formed in ways different than the present embodiments. Moreover, in some configurations one or more layers of other material may be disposed between the two layers.

FIG. 3 shows another embodiment of a stab fork assembly 10. This embodiment includes a base 14, a body 16, and tips 22, in similar fashion to the stab fork assembly 10 embodiment illustrated in FIG. 1. Additionally, the body 16 of the stab fork assembly shown in the FIG. 3 features a concave middle region 44. The concave middle region 44 comprises an outward bend and an inward bend of the fingers 18 at a relatively higher point along the fingers, as more clearly illustrated in FIG. 3. These bends do not include the outward bend of the tips 22, which generally occurs at a higher point. The concave region may be formed or configured in a number of ways, as deemed desirable for particular applications. In one or more embodiment, a stab fork assembly 10 may comprise one or more concave regions 44, with bends that may or may not be defined at “concave”, or that may be more or less so.

The body 16 of the stab fork assembly 10 may take on many configurations, as is determined suitable for the stab to be received and the environment in which it is used. Two such embodiments of the body 16 of a stab fork assembly are illustrated in the present disclosure, one having a straight body and one having a body comprising a concave region 44. Some other embodiments may have alternate configurations such as multiple concave regions 44, support bars, and so forth.

The base 14 of the stab fork assembly 10 is illustrated in the present embodiments as bending outward and away from the stab fork assembly 10, and having apertures 26 for securing the base 10 to a bus bar or other fixture. Some other embodiments may feature bases 10 bending inward, towards the middle of the stab fork assembly, or some alternate configuration. In some embodiments, the bases 10 may be coupled together or formed from one piece. Further, the attachment mechanism may be something other than apertures 26, such as that being used with clamps, clips, ties, and so forth.

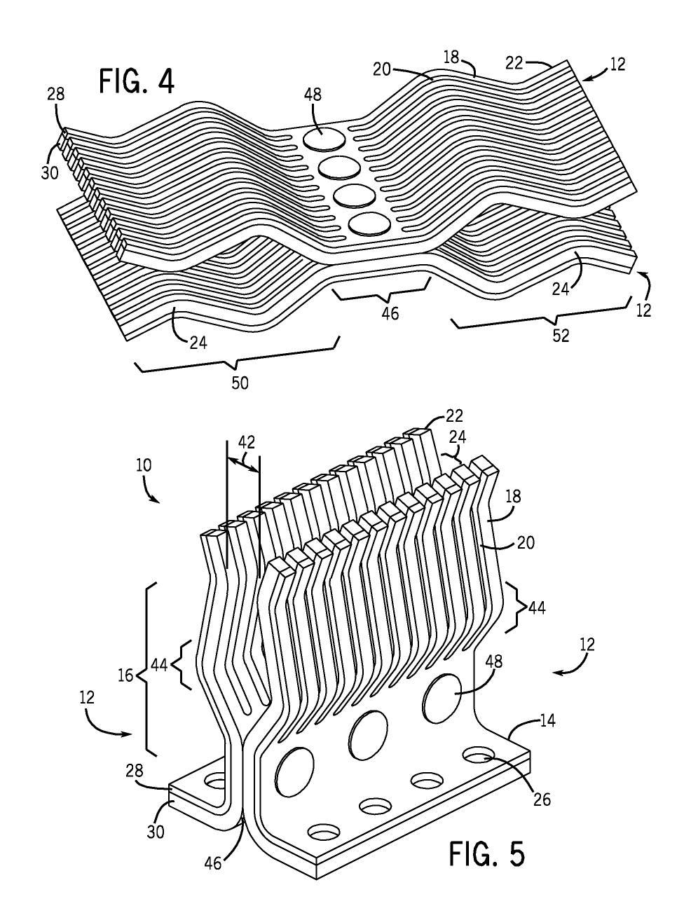

FIG. 4 shows another embodiment of a stab fork assembly 10. This embodiment features a fastening region 46 and fasteners 48. This embodiment also features a first forked end 50 and a second forked end 52, such that each stab fork 12 has two bodies, each comprising a plurality of fingers 18, slits 20, tips 22 disposed in laterally opposing relation. The fastening region 46 of each stab fork 12 is disposed between the first forked end 50 and the second forked end 52. The first forked end 50, the fastening region 46, and the second forked end 52 are generally formed from a continuous piece of material, but need not be. As further shown in FIG. 4, the fastening regions 46 of two stab forks 12 are generally fastened together by fasteners 48 such that the stab forks 12 are disposed in mutually facing relation with the conductive layer 30 of one stab fork facing the conductive layer 30 of the joining stab fork, and such that the tips 22 of each stab fork 12 bend outward and away from the tips 22 of the joining stab fork. The fastening regions 46 of the two stab forks are generally intimately secured to each other such that the two stab forks 12 move as one body.

FIG. 4 illustrates an embodiment of the stab fork assembly 10 having a first forked end 50 and a second forked end 52 being laterally connected to each other by a fastening region, such that the first forked end and the second forked end are disposed generally along the same plane. Some embodiments of a stab fork assembly 10 may be configured to have a first forked end 50 that is disposed at an angle to a second forked end 52, rather than being disposed in a straight line. In such configurations, the fastening region 46 may be where the angle originates. Further, these embodiments may include a means of disposing the stab fork assembly 10 onto another fixture. Additionally, the bodies of the first forked end 50 and second forked end 52 are subject to a variety of configurations, such as being straight rather than having a concave region.

FIG. 5 illustrates one embodiment of the stab fork assembly 10. Each stab fork 12 of this embodiment includes a base 14, a body 16 featuring a plurality of fingers 18, slits 20, tips 22, and a concave middle region 44, similar to that the embodiment of FIG. 3. Additionally, the stab forks 12 of the embodiment of FIG. 5 feature a fastening region 46 disposed above and adjacent to the base 14. The two stab forks 12 are joined together at the fastening region 46 with fasteners 48 such that the stab forks 12 are in mutually facing relation with both sets of tips 22 pointing outward and away from each other. The fastening regions 46 of the two stab forks 12 are generally intimately secured to each other such that the two stab forks move as one body.

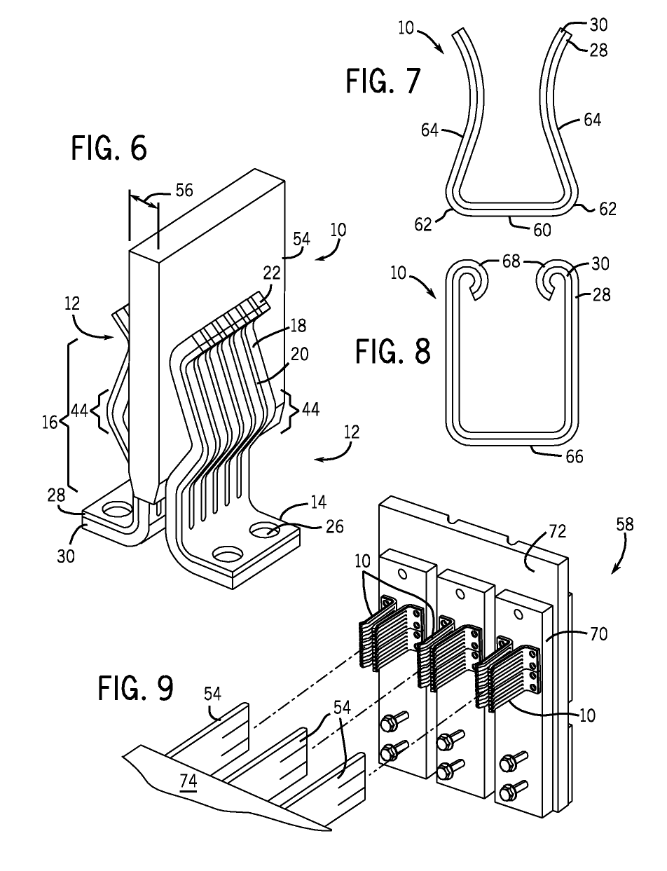

FIG. 6 illustrates an embodiment of a stab assembly 10 having received a stab 54. The stab 54 is generally inserted into the stab fork assembly from the top, and travels laterally down the body 16 toward the base 14 until it is fully disposed. As the stab 54 makes contact with and is disposed through the primary contact regions 24, the stab 54 and the stab fork assembly 10 become electrically coupled.

In some embodiments, the stab width 56 may be larger than the first contact distance 42 when the stab fork assembly 10 is in a neutral position but generally not larger than the largest distance between the tips 22, which generally occurs at the very end of the tips 22, such that the naturally outwardly bending tips guide the stab into the first contact region 24. When the stab 54 is disposed past the first contact region 24, the stab forks 12 are generally outwardly separated by the incoming stab. Neutral position refers to the position of a stab fork assembly 12 when it is not interacting with a stab or being subject to external forces with the exception of forces related generally to the attachment of the base 14 to a fixture. Since the base 14 of the stab fork assembly 10 may generally be secured such it does not move or separate when a stab is inserted, the widening of the first contact distance 42 generally causes an outwardly bending deformation in the body 16 or between the body 16 and the base 14 in order to accommodate the stab 54. When the stab 54 is fully disposed in the stab fork assembly 10, the first contact distance is generally the same as the stab width 56. As the stab forks 12 are elastically deformed to accommodate the increase in the first contact distance when a stab 54 is inserted, a restoring or contact force is generated, which keeps the fingers 18 urged into contact with the inserted stab 54. This contact force is generally determined by several factors relating to the shape, material, geometric configuration, dimensions, thickness and so forth of the fingers, as well as the number of fingers (or more generally, the width of the structure).

The first contact distance 42 (FIG. 1) of a stab fork assembly 10 in neutral position is generally related to such factors as the distance between the two bases 12, the degree of curvature between the base 12 and the body 16, the length of the body 40, and the configuration of the body, such as being straight or having structural elements such as a concave region. Likewise, the contact force on the stab by the stab fork assembly 10 depends generally on such factors as, in additional to the above, the elastic modulus of the stab fork assembly material, the geometric configuration of the stab fork assembly 10 (e.g., length, width, thickness, shape), and amount of displacement or deformation of the stab fork assembly 10. Thus, different configurations may be used for different applications and to obtain different desired specifications, such as contact force, size, and so forth, as will be exercised by one skilled in the art. Accordingly, there is a high degree of design flexibility associated with the present disclosure while staying within the creative principles and essence of the present disclosure.

FIG. 7 illustrates another embodiment of the stab fork assembly 10. This embodiment includes a continuous base 60, which is formed by bending a continuous piece of material at two corners 62. This also provides two upright stab fork walls 64 approximately perpendicular to the continuous base 60 for receiving the stab 54. Additionally, this embodiment is generally configured such that the steel layer 28 is on the outside of the stab fork assembly 10 and the conductive layer 30 is on the inside of the stab fork. The steel layer 28 provides mechanical support and the conductive layer 30 makes contact with the inserted stab 54.

FIG. 8 illustrates yet another embodiment of the stab fork assembly 10. This embodiment includes a continuous base 66 and two upright stab arms which terminate at respective inwardly curved tips 68, as illustrated. This embodiment is configured such that the steel layer 30 is generally on the inside of the stab fork assembly 10 and the conductive layer 28 is generally on the outside of the stab fork assembly 10, such that the conductive layers 28 of the inwardly curved tips 68 are configured to be mutually facing. Such an embodiment allows the stab 54 to be in contact with the conductive layer 28 of the stab fork assembly 10 as the stab 54 is inserted into the stab fork assembly 10. However, because the conductive layer 28 is generally on the outside of the stab fork assembly 10, such as at the continuous base 66, the stab fork assembly 10 may conduct power from the stab 54 to the outside of the continuous base 66. This configuration allows the stab fork assembly 10 to be mounted on a bus bar with the conductive layer 28 of the continuous base 66 conducting power from the stab 54 to the bus bar.

FIG. 9 illustrates an embodiment of the stab fork assembly 10 as it may be used as a part of a power stab assembly. The power stab system 58 of this embodiment features three stab fork assemblies 10 mounted onto bus bars 70, which are mounted onto a support 72, generally to receive three-phase power. The bases 14 of the three stab fork assemblies 10 embodied here are mounted onto the bus bars via apertures 26. The embodied power stab system 58 is generally used with a stab connector device 74 coupled to three stabs 54. The stab connector device 74 and stabs 54 are configured in general alignment with the power stab system 58 such that when engaged, each stab 54 is inserted into the respective stab fork 10, establishing a conductive connection.

The embodiments of FIG. 1-9 illustrate the stab fork assembly 10 as being comprised of two stab forks 12 of generally identical configurations or a stab fork assembly with a continuous base as illustrated in FIGS. 7 and 8. This may be advantageous in some applications. However, one or more embodiments may utilize two dissimilar stab forks 12 to compose a stab fork assembly 10. One such embodiment might mix one of the stab forks 12 embodied in FIG. 1 with one of the stab forks 12 embodied in FIG. 3, such that the composed stab fork assembly comprises one stab fork 12 without a concave region 44 and one stab fork 12 with a concave region 44. This as well as some other stab fork assembly configuration comprising two generally non-identical stab forks may be advantageous in the case that the stab to be received by the stab fork assembly 10 is configured differently on its two sides. Having a stab fork assembly 10 configured with 2 different stab forks, each configured in accordance with the respective side of the stab, would possibly provide a more robust connection.

Another embodiment of the stab fork assembly 10 may comprise only one stab fork 12 disposed in mutually facing relation with a non-forked support (not illustrated). Unlike the two stab forks illustrated in the figures, one stab fork may be replaced by a non-forked support, such that when the stab and stab fork assembly 10 are fully disposed, one side of the stab is in contact with the stab fork 12, and the other side of the stab is in contact with a non-forked support.

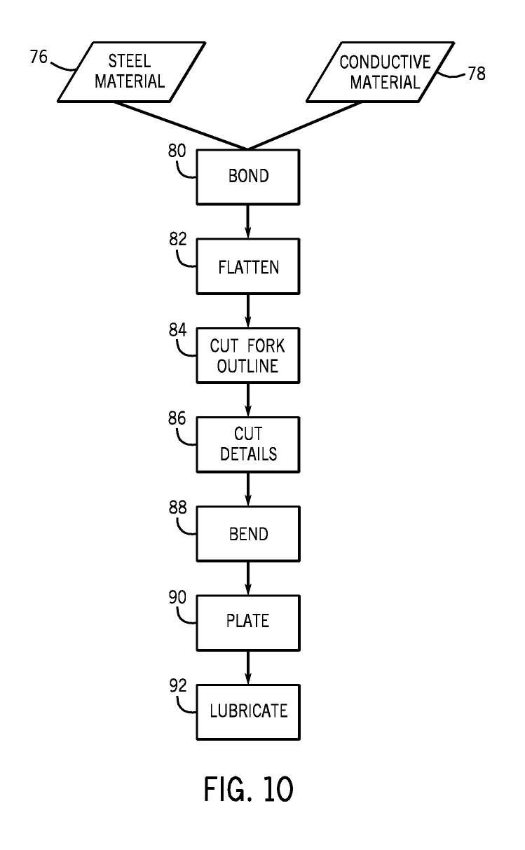

FIG. 10 illustrates via a flowchart an embodiment of a method for making a stab fork assembly. The process begins with raw materials of steel 76, such as spring steel, and a highly conductive material 78, such as copper. In the present embodiment, the two materials are first bonded to each other, as indicated by reference numeral 80. This may generally be done through explosive bonding or some other techniques of intimately bonding two materials. The next step in this embodiment is to flatten the bonded material, as indicated at step 82. The materials may be bonded in a generally flattened state, and the bonded combination may then be processed (e.g., rolled or otherwise flattened or worked) to the desired thickness of the stab fork 12. In the present embodiment, the general shape of the stab forks is cut, as indicated by reference numeral 84, and then the details of the stab fork are formed (e.g., cut), as indicated by reference numeral 86. For example, the general shape of a stab form refers to the main outline of the stab 12, excluding the individual slits 20 and the apertures 26. This division of steps may be advantageous since many embodiments of the stab fork assembly 10 may include stab forks 12 of identical general shape, but differing details such as number of forks 18 and apertures 26. This way, several embodiments may be mass manufactured together until the steps relating to cutting or forming the detailed features, saving time and resources. In the present embodiment, the cut out shapes are then bent at step 88 into desired stab fork shapes, generally involving outwardly bending tips, loosely perpendicularly bent bases, concave regions in some embodiments, and other configurations more illustrated in the present disclosure. In one presently contemplated embodiment, the entire surface of the stab fork may be plated, such as with silver or some other material to lower contact resistance, avoid fretting, and prevent oxidation as indicated at step 90. The finished structure may then be lubricated to guard against possible corrosive environments and reduce friction, as indicated at step 92. The above embodiment of a method for making a stab fork assembly illustrates one possible configuration of steps. Other possible embodiments may combine steps, further separate steps, switch the order of some steps, and add or remove steps while maintaining the essence of the present disclosure.

As mentioned above, the bonding of the copper and steel materials, as indicated by reference numeral 80, may be accomplished through explosive bonding. In the explosive bonding process, a first material is placed on top of a second material, leaving a small distance in between to allow for acceleration. Explosive material is typically placed on top of the first material such that when ignited, the explosive force causes the first material to be accelerated towards the bottom material, obtaining a very high impact velocity when it collides with the second material. The impact results in high localized pressure of the first material onto the second material, bonding the two materials. Explosive bonding generally produces a robust bond while maintaining the characteristics of each bonded material. This may be advantageous as the present invention benefits from the elastic and strength characteristics of the steel material as well as the conductive characteristics of the copper material. Explosive bonding may also aid in maintaining a solid bond between the dissimilar materials, and reduce the risk of separation or delamination during later working and use.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electric power stab system, comprising:
first and second conductors disposed in mutually facing relation, each conductor comprising a conductive layer on an inner side of the conductor and a spring biasing layer bonded to only one side of the conductive layer on an outer side of the conductor, the conductive layer comprising a metal of substantially higher conductivity than the spring biasing layer, the spring biasing layers urging the conductive layers towards a mating stab element when inserted between the first and second conductors for carrying electrical current primarily through the conductive layer.

2. The system of claim 1, wherein the conductive layer is at least as thick as the steel layer.

3. The system of claim 2, wherein the spring biasing layer is at least at thick as 20% of the thickness of the conductive layer.

4. The system of claim 1, wherein the conductive layer comprises copper, a copper alloy, aluminum or an aluminum alloy.

5. The system of claim 4, wherein the spring biasing layer comprises a spring steel.

6. The system of claim 1, wherein each conductor comprises a base portion configured to be fixed to a bus conductor, and an extension rising from the base for receiving the stab.

7. The system of claim 1, wherein each conductor comprises a securement region configured to be fixed to the securement region of the other conductor.

8. The system of claim 1, wherein each conductor comprises a plurality of slits defining conductive fingers configured to contact the stab.

9. The system of claim 8, wherein each of the conductive fingers comprise a generally straight body and an outwardly curved tip.

10. The system of claim 8, wherein each of the conductive fingers of each conductor comprise a concave base facing a similar concave base of the conductive fingers of the other conductor, and an outwardly curved tip.

11. The system of claim 1, wherein the first and second conductors are substantially identical.

12. The system of claim 1, wherein the conductors have two stab-receiving ends opposite each other

13. An electric power stab system, comprising:
a conductive material bonded to a material of high elastic modulus, wherein portions of the bonded materials face each other, the conductive material being disposed on an inner, contact side and the high elastic modulus material being disposed on an outer side opposite the contact side to urge the conductive material towards a contact position when used in an electrical connection.

14. The electric power stab system of claim 13, wherein the bonded material is configured to be a conductor, wherein the conductor comprises:
a base portion configured to be fixed to a bus conductor, and an extension rising from the base for receiving a stab;
a securement region configured to be fixed to the securement region of a second like conductor; and
a plurality of slits defining conductive fingers configured to contact the stab, the conductive fingers further comprising a generally straight body, an outwardly curved tip, and a concave base facing a similar concave base of the conductive fingers of the second like conductor.

15.-20. (canceled)
